(19) United States
(12) Patent Application Publication
(10) Pub. No.: US 2010/0175970 A1
(43) Pub. Date: Jul. 15, 2010

(54) RESIDUAL CURRENT CIRCUIT BREAKER CONTROLLING AND AUXILIARY APPARATUS, AND RESIDUAL CURRENT CIRCUIT BREAKER EQUIPPED THEREBY

(76) Inventor: Giovanni Pieri, Viareggio (IT)

Correspondence Address: DENNISON, SCHULTZ & MACDONALD, 1727 KING STREET, SUITE 105, ALEXANDRIA, VA, 22314, US

(21) Appl. No.: 12/601,957

(22) PCT Filed: May 27, 2008
(86) PCT No.: PCT/IB2008/001337

§ 371 Date: Dec. 30, 2009

(30) Foreign Application Priority Data
May 28, 2007 (IT) LU2007A000011

(51) Int. Cl. H01H 9/00

(52) U.S. Cl. 200/238

(57) ABSTRACT

The apparatus allows measuring the presence of damages to the induced circuit (15) of a residual current circuit breaker (200), or of a blocked electromechanical releasing device (11) of residual current circuit breaker (200), and to operate in one qf said two cases a releasing device (20) additional to that (11) of residual current circuit breaker (200). This can be obtained, on the one hand, determining if there is or less a current flow in the induced circuit (15) of the residual current circuit breaker beyond a minimum threshold, or if there is on the other hand a current flow beyond a maximum threshold. The absence of this minimum current in the induced circuit (15) causes the opening of additional releasing device (20). In the latter case, it is possible to obtain this feature by establishing when induced circuit (15) of residual current circuit breaker (200) is flown by a current beyond the maximum threshold. In this case, this excessive current in induced circuit (15) causes the opening the additional releasing device (20).

### FIELD OF THE INVENTION

The present invention relates to an apparatus for signalling a failure and ensuring also, in case of failure, to operate a residual current circuit breaker used for breaking automatically an electric circuit in case of anomalous current leakage from a phase of said circuit towards ground. In particular, a residual current circuit breaker is used for protecting from indirect and direct contacts, i.e. from the risk of electrocution, a person who contacts a part of a circuit under voltage, causing a phase-ground bridge. This part under voltage can be a conductor normally under voltage, or an exposed component incorrectly connected to the ground of an electric equipment connected to the circuit.

### BACKGROUND OF THE INVENTION

The specific task of a residual current circuit breaker located on a supply circuit of a group of electric users consists of:

opening the supply circuit when the current that flows from a metal mass accidentally under voltage of one of such electric users and the ground is higher than a predetermined threshold;

opening the circuit in case of direct contact between a metal mass normally under voltage of an electric user and the ground, typically through the body of a person.

In FIGS. 3A and 3B a diagrammatical view is shown of a single-phase residual current circuit breaker 100 according to the prior art, whose operation is described below.

The residual current circuit breaker 100 is made up essentially of a click mechanism for closing and opening the contacts between two couples of points [7-8] and [9-10], respectively of phase conductor F and of neutral conductor N, this mechanism being substantially identical to common automatic switches, but operated by release means 11a (FIG. 3B), responsive to the difference of the currents flowing in conductors F and N. Contacts [7-8] and [9-10] are in fact integral to a shaft 12, subject to a magnetic field of permanent magnet 13. Without any actions, the forces associated with this magnetic field contrast the action of a compressed spring 14, maintaining shaft 12 in position 12a, this position being a closed position for contacts [7-8] and [9-10]. When instead in a induced circuit 15 (called also detector winding or differential circuit), and then also in a winding 16, a current flows having enough intensity, it generates locally a magnetic field opposite to that associated with magnet 13, such that shaft 12, not longer held in position 12a, moves to position 12b under the action of spring 14, opening contacts [7-8] and [9-10]. In other words, a polarized relay 11 becomes demagnetized causing the circuit to open. Such is the operation of the residual current circuit breaker 100.

Still referring to FIG. 1, the switch 100 is integrated with a magnetothermic switch 32.

Such a residual current circuit breaker is characterised by a nominal differential current IΔn, which is a rating of the residual current circuit breaker. The current values for which the opening must occur have to be higher than 0.5 IΔn, and the opening must occur within a time span complying with safety rules. For example, the common residual current circuit breakers in home electrical installation have IΔn set at 30 milliampère, i.e., the switch must operate when a current circulates higher than 15 milliampère within a time span prescribed by the rules.

Such operation is ensured, unless a fault is present. In particular, a switch as the above described one may be out of order as a residual current circuit breaker for at least one of two fault conditions, i.e.:

a breaking of the differential circuit or induced circuit 15,

a gripped mechanism of relay 11.

Moreover, such conditions occur without shutting off the power supply to supplied circuit, nor emitting any warning signal.

To take this fact into account, the existing residual current circuit breakers, are equipped with a test device, in particular, a test key T (see FIG. 3A), incorporated in the switch, that, once actuated, simulates the conditions of differential current causing operation of the residual current circuit breaker in specified conditions, and lets know if the switch 100 is operative or not as a residual current circuit breaker. Pushing the test switch, test circuit 18 is closed; this way, phase conductor F is connected to neutral conductor N causing a current of intensity suitable far operating residual current circuit breaker 100, if this is undamaged, i.e. is free from the above indicated faults. Test circuit 18 comprises in fact a resistance 19, chosen suitable for simulating a leakage current exceeding IΔn. In order to know whether the residual current circuit breaker is operative or out of order, it is necessary to push test button T to test whether relay 11 operates opening contact [7-8] of phase conductor F and contact [9-10] of neutral conductor N, interrupting then the power supply to the circuit.

However, the frequency of this tests relies upon the care of the users, especially in home applications. Between two consecutive tests a long time span may pass, during which the residual current circuit breaker 100 may be damaged for at least one of the above explained reasons, without any interruption of power supply to the circuit, or emission of any warning signal. Therefore, a condition of serious danger may arise for users or subject exposed to equipment connected electrically to the mains through an out-of-order residual current circuit breaker.

### SUMMARY OF THE INVENTION

It is therefore a feature of the present invention to provide a residual current circuit breaker that breaks the supply to an electric single-phase or three-phase circuit, with or without neutral conductor, in case of failure of said residual current circuit breaker.

It is also a feature of the present invention to provide a residual current circuit breaker that emits a warning signal in case of failure of said residual current circuit breaker.

It is yet a feature of the present invention to provide a device adapted to be associated with a residual current circuit breaker that breaks the supply or emits a warning signal, also in case of failure of said residual current circuit breaker.

These and other objects are achieved through a residual current circuit breaker as defined by claim 1.

Other aspects of the invention are defined by the dependent claims.

According to the invention, it is possible to detect the presence of either damages to the induced circuit of the residual current circuit breaker, or a gripped electromechanical releasing device of the residual current circuit breaker, and to operate in one of said two cases an additional releasing device further to that already present in the residual current circuit breaker.

This can be obtained, on the one hand, by determining whether there is a current flow in the induced circuit of the residual current circuit breaker beyond a minimum threshold, or whether there is, on the other hand, a current flow beyond a maximum threshold.

In the first case, it is possible to obtain this feature by introducing artificially between two conductors, in which current normally flows in and out, and which are provided in the residual current circuit breaker, a current that is perceptible as differential current between said two conductors, for determining if the induced circuit of the residual current circuit breaker is damaged when it is not flown by any induced current. In this case, the absence of this minimum current in the induced circuit causes the additional releasing device to open.

In the latter case, it is possible to obtain this feature by determining when in the induced circuit of the residual current circuit breaker a current flows beyond the maximum threshold. In this case, this excessive current in the induced circuit causes the additional releasing device to open.

### BRIEF DESCRIPTION OF THE DRAWINGS

The invention will be made clearer with the following description of some exemplary embodiments, exemplifying but not limitative, with reference to the attached drawings wherein:

FIG. 3A shows a diagrammatical view of a residual current circuit breaker according to the prior art;

FIG. 3B shows More in detail, a relay connected to the releasing device of the residual current circuit breaker of FIG. 1A;

FIG. 1 is a diagrammatical view of a residual current circuit breaker having an apparatus according to the invention, which has normally open contacts for breaking an electric circuit;

FIG. 2 is a diagrammatical view of a residual current circuit breaker having an apparatus according to the invention, which has normally closed contacts;

FIG. 1A is a diagrammatical view of a residual current circuit breaker similar to the switch of FIG. 1, with an exemplary embodiment of the branch circuit;

FIG. 1B is a diagrammatical view of a residual current circuit breaker similar to the switch of FIG. 1, with two induced circuits and a single ring;

FIG. 1C is a diagrammatical view of a residual current circuit breaker similar to the switch of FIG. 1B, with the two induced circuits wound on two different rings;

FIG. 2A is a diagrammatical view of a residual current circuit breaker similar to the switch of FIG. 2, with an exemplary embodiment of the branch circuit similar to that of FIG. 1A;

FIG. 2B is a diagrammatical view of a residual current circuit breaker similar to the switch of FIG. 2, with two induced circuits and a single ring;

FIG. 2C is a diagrammatical view of a residual current circuit breaker similar to the switch of FIG. 2B, with the two induced circuits wound on two different rings.

### DESCRIPTION OF PREFERRED EXEMPLARY EMBODIMENTS

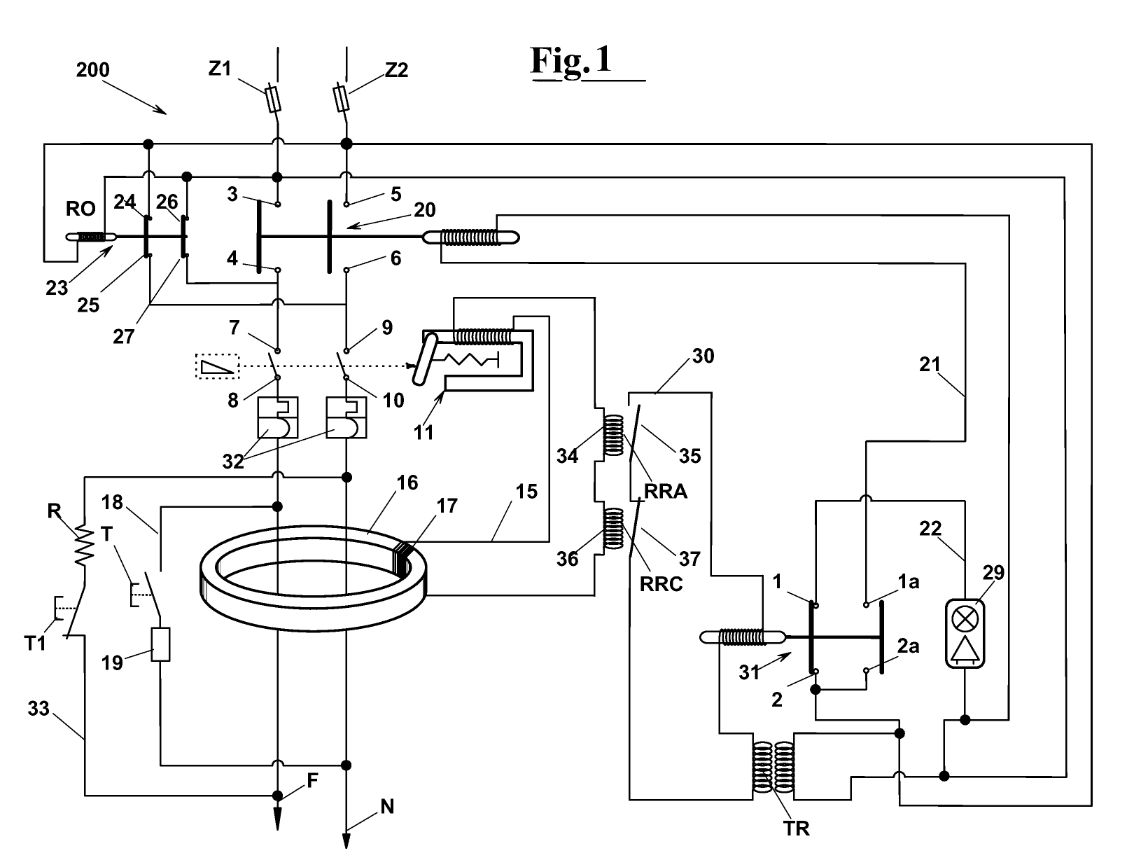

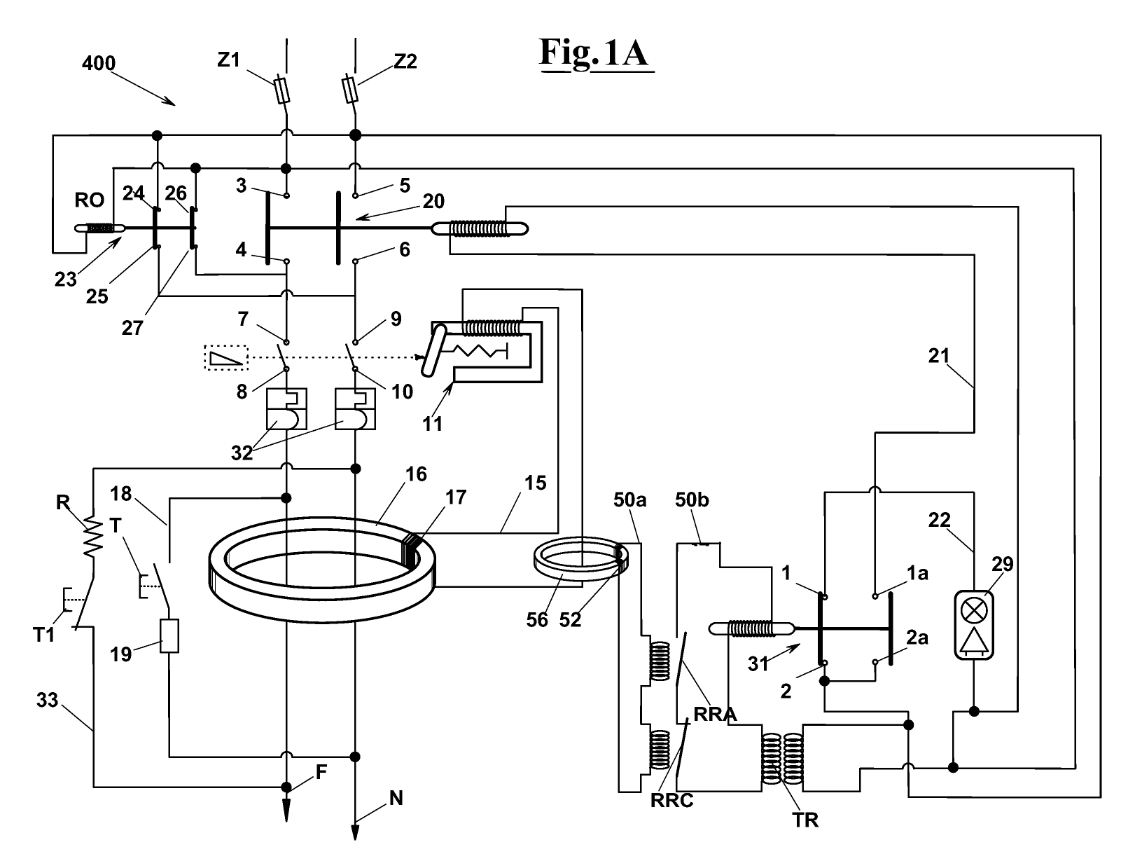

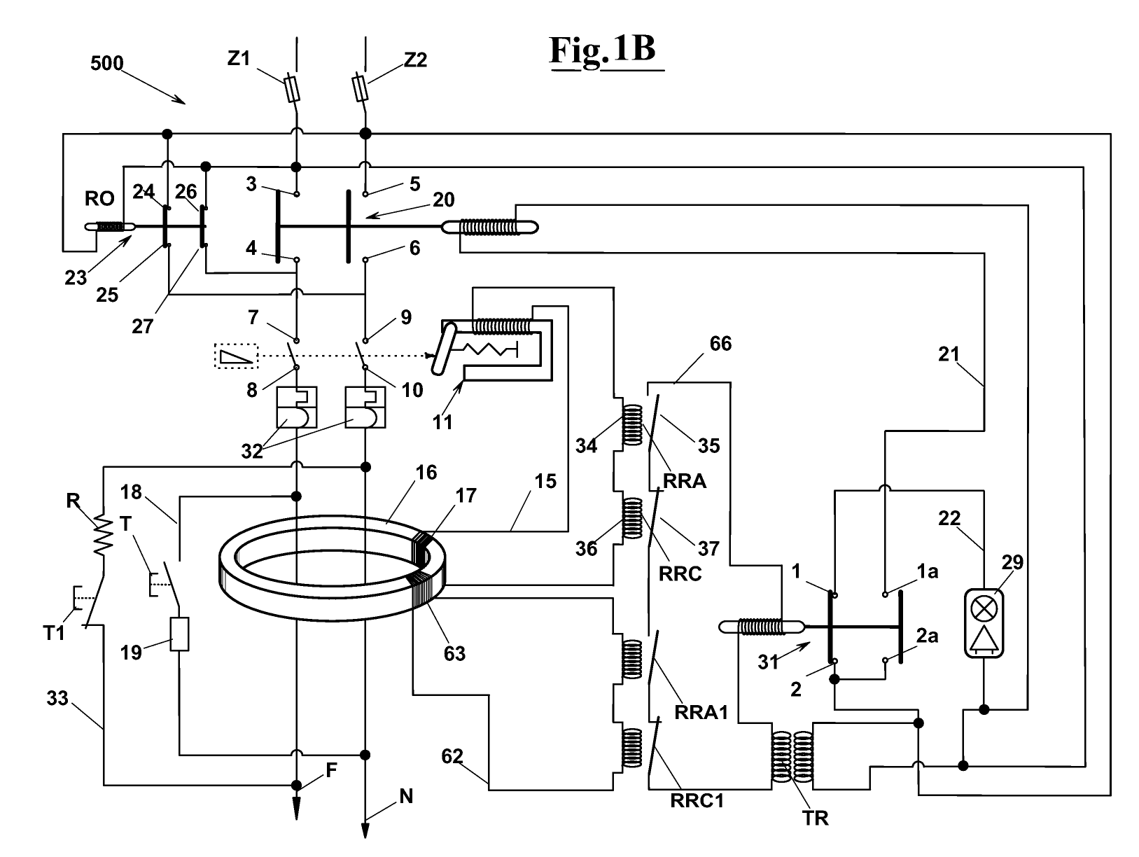

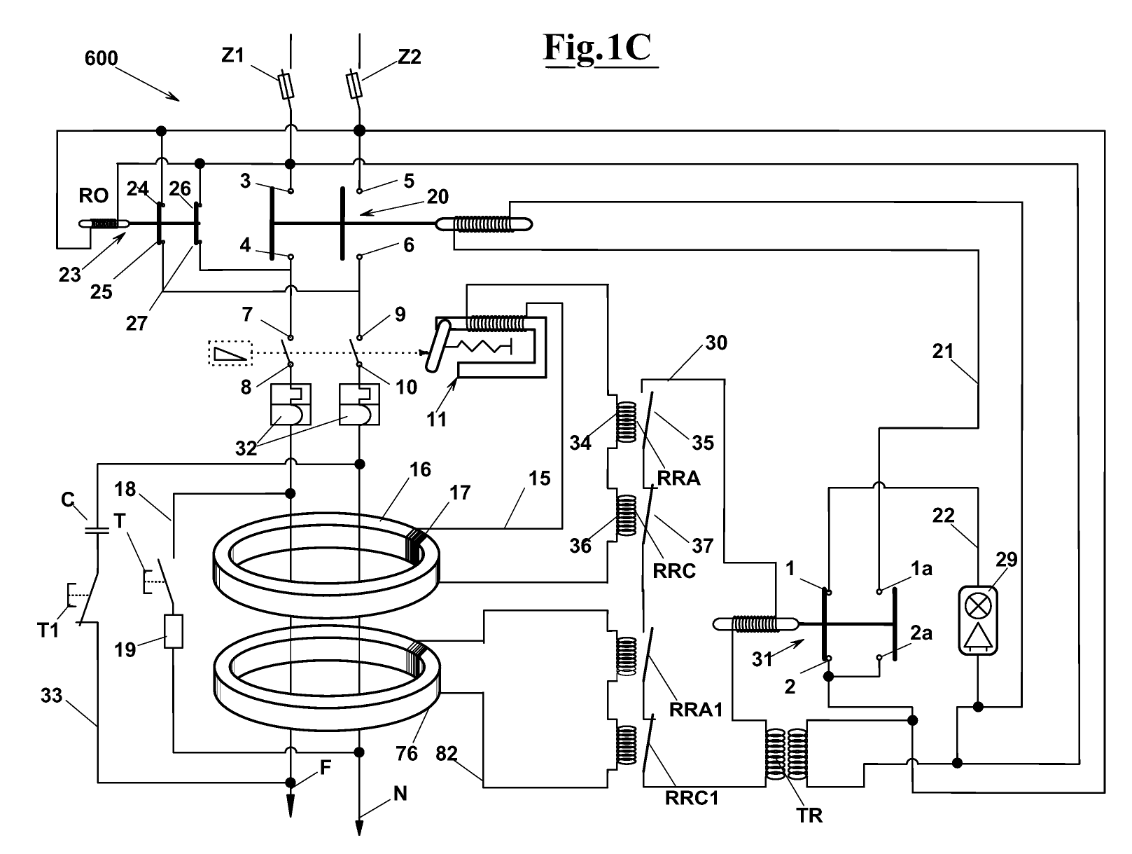

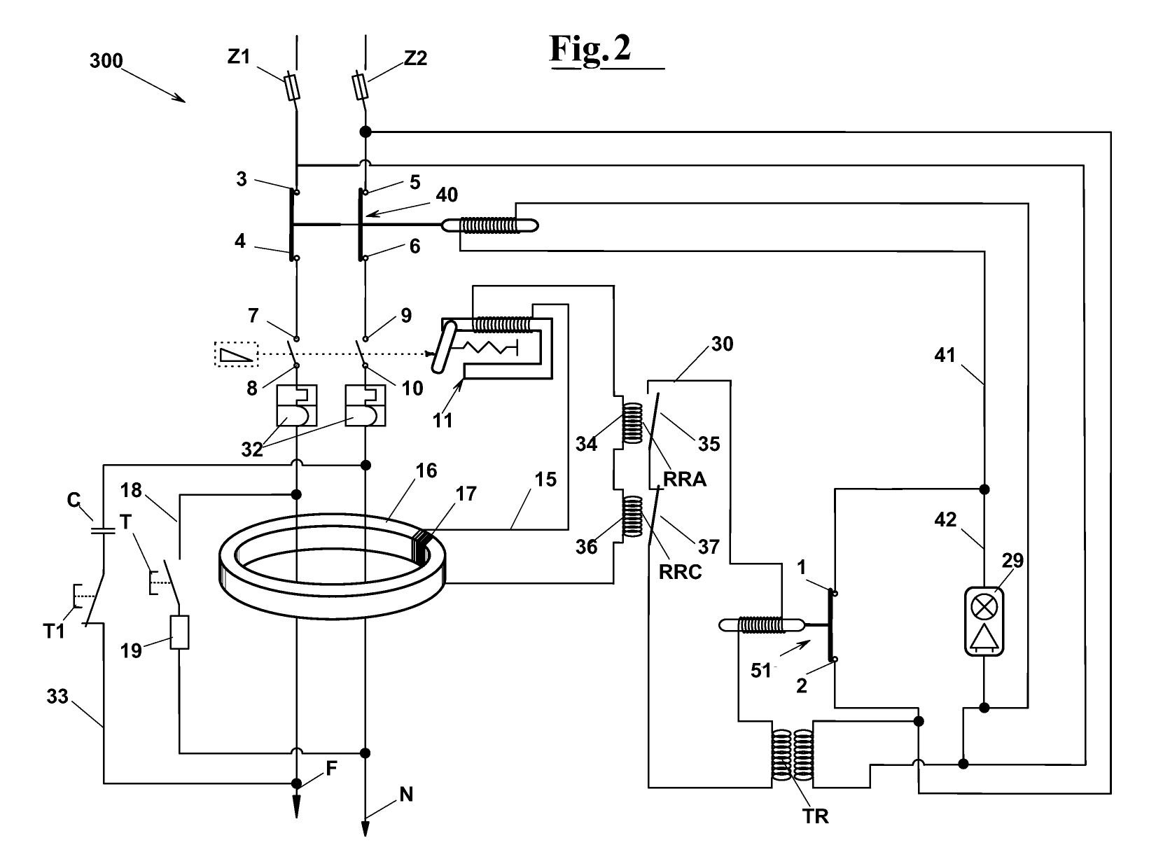

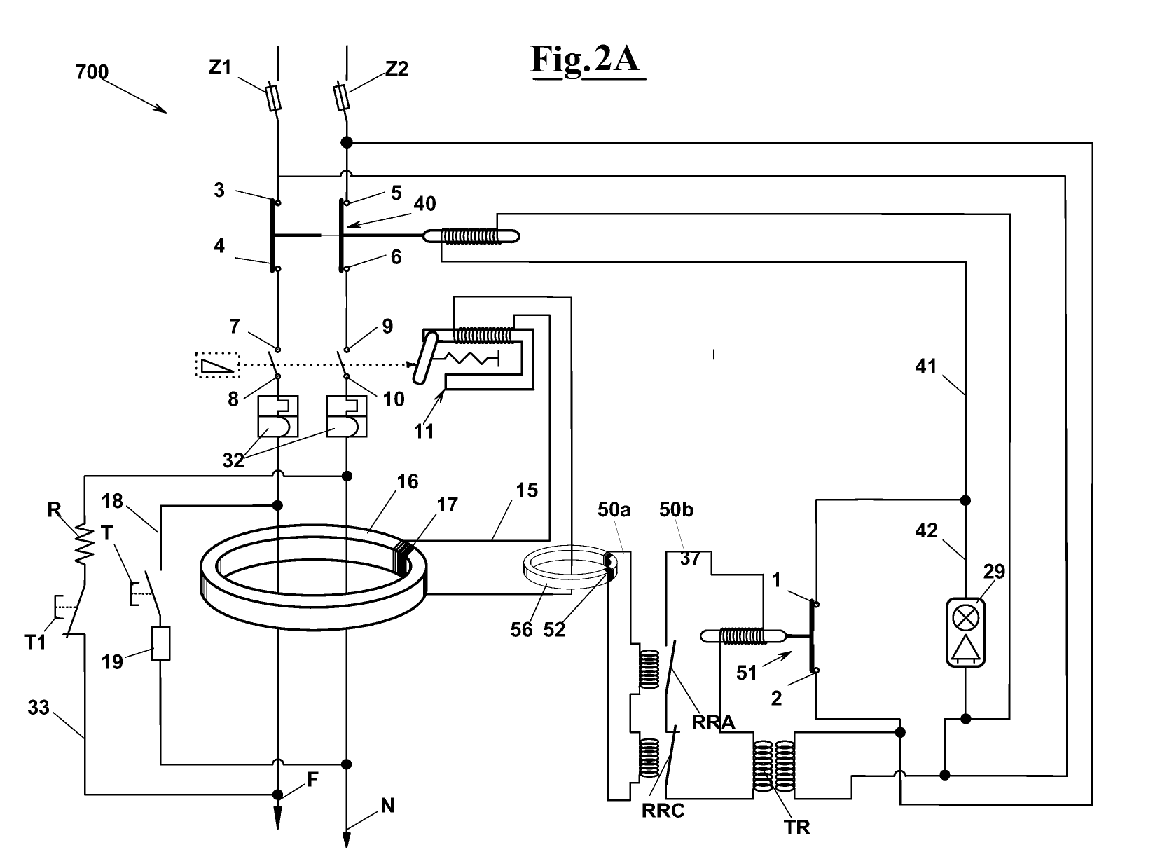

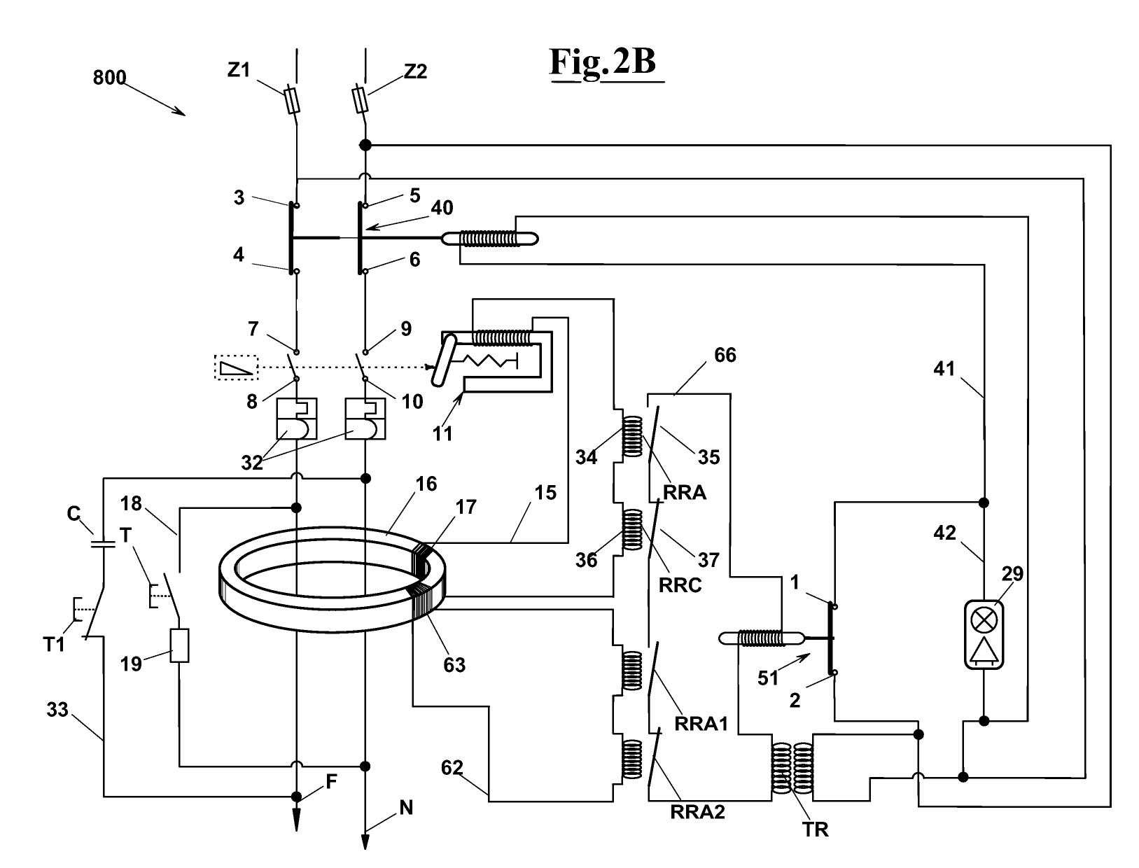

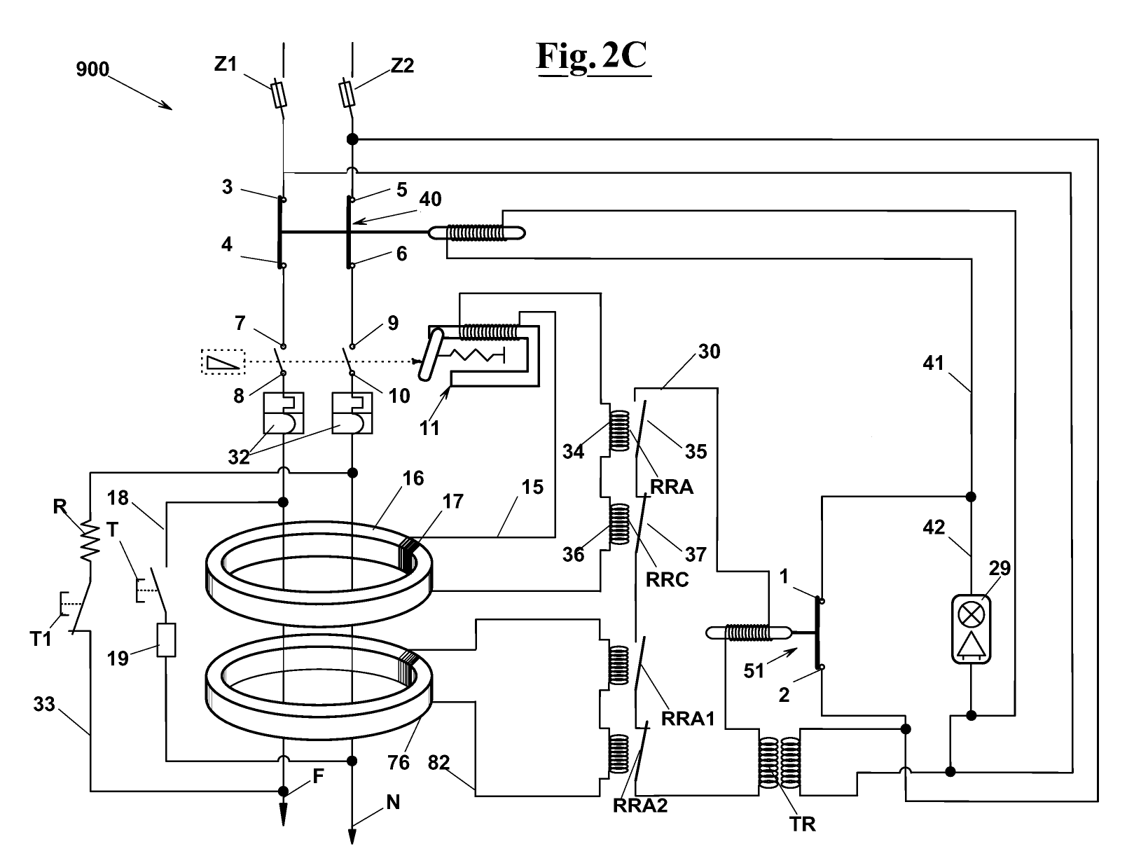

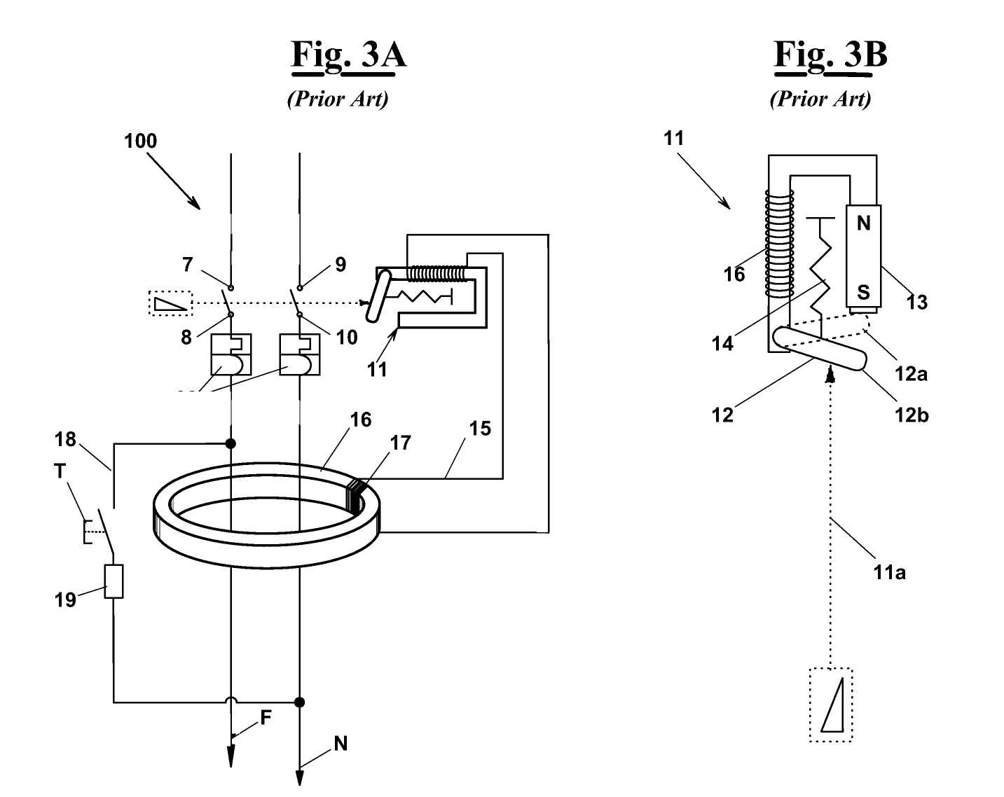

Reference is made now to the diagrammatical view of a single-phase residual current circuit breaker 100 shown in FIGS. 3A and 3B as previously described (see “Background of the invention”). As described below, the circuit breaker has an apparatus for detecting conditions of failure and ensuring its operation, according to the invention, obtaining an improved residual current circuit breaker as hereinafter described in various exemplary embodiments.

With reference to FIG. 1, relative to a first exemplary embodiment, the single-phase residual current circuit breaker 200 comprises:

a contactor 20, having normally open contacts [3-4] and [5-6] respectively on a phase conductor F and on a neutral conductor N, respectively arranged upstream from contacts [7-8] and [9-10] of the residual current circuit breaker;

a warning device 29,

two complementary circuits 21 and 22, supplied directly by the mains, which work for operation respectively of contactor 20 and of warning device 29; in series to them, in the circuits 21 and 22 there are respectively contacts [1a-2a] and [1-2] of a relay 31, which are integral and opposite to each other, i.e. one is closed when the other is open.

a branch circuit 30 for operating relay 31, on which the contacts of “dry reed relay”, respectively RRA, normally open, and RRC, normally closed are arranged in series; branch circuit 30 is supplied by the mains through a transformer TR;

two windings 34 and 36 of dry reed relay RRA and RRC, arranged in series on induced circuit 15 of residual current circuit breaker 200;

a resistance R arranged on a conductor 33 in series with the contact of a test button T1, between phase conductor F and neutral conductor N, having a resistance that generates a current of a few milliampère in induced circuit 15;

a relay 23.

Upstream from contactor 20, for protection against short circuits, a switch is then arranged with fuses Z1 and Z2.

Alternatively to the RRC inductor a fuse can be used; instead of transformer TR, for causing the current to flow in branch circuit 30, another system can be used, for example an electronic feeder.

In branch circuit 30 the current flows if induced circuit 15 is undamaged, since RRA inductor closes its contacts, normally open, even for predetermined minimum current values, and then intervenes in case of failure to break induced circuit 15; RRC inductor, instead, opens its contacts, normally closed, only for current values higher than a predetermined threshold, and then intervenes in case of failure owing to a gripped mechanism of relay 11.

Then, in case of break of induced circuit 15, in branch circuit 30 there is no current, therefore contacts [1-2] turn to a closed status; in complementary circuit 22, supplied by the mains, a current flows, and device 29 emits a warning signal. Contacts [1a-2a], integral to [1-2], instead, turn to an open status, and so in complementary circuit 21 there is no current, therefore, contacts [3-4] and [5-6], of normally open type, turn to an open status.

In the event that induced circuit 15 is undamaged, but a current flows in it higher than that necessary to operate relay 11, and undesirably contacts [7-8] and [9-10] do not open because the releasing device of relay 11 is blocked, in this case RRC inductor intervenes, suitably calibrated, which opens branch circuit 30. Even in this case in branch circuit 30 there is no current, therefore:

Contacts [1-2], which are normally closed contacts, cause a current to pass in complementary circuit 22, supplied by the mains supply, which operates alarm 29;

Contacts [1a-2a], integral and opposite to contacts [1-2], turn to an open status, therefore complementary circuit 21 is discontinued and opens normally open contacts [3-4] and [5-6], of contactor 20.

Alternatively, instead of resistance R, for causing a small current to flow in induced circuit 15 a capacity can be used, as in the case of switch 300 of FIG. 2.

Hereinafter, the operation is described of the single-phase residual current circuit breaker 200, equipped with the apparatus according to the above described invention, in the following possible situations:

a) regular operation without failure,
b) irregular operation with failure owing to broken induced circuit,
c) irregular operation with failure owing to a gripped mechanisms and current flow in the induced circuit higher than allowable limits,
d) first installation of the circuit breaker,
e) interruption of the supply for external causes and its restoration,
f) total failure of the apparatus according to the invention associated to the residual current circuit breaker.
a) Regular Operation without Failure.

Contacts [7-8] and [9-10] are closed, then current flows in induced circuit 15 and in branch circuit 30, such that this current flows, by relay 31

keeps contacts [1-2] turn to an open status and then in complementary circuit 22 there is no current, avoiding that device 29 emits a warning signal,

keeps contacts [1a-2a] turn to a closed status and then in complementary circuit 21 a current flows, avoiding, by relay 20, that contacts [3-4] and [5-6] turn to an open status.

In case of regular activation of residual current circuit breaker 200, without failure, contacts [7-8] and [9-10] turn to an open status, because in induced circuit a current flows adapted to trigger relay 11. The current circulating in induced circuit 15 causes the contacts of RRC inductor to turn to an open status, whereby branch circuit 30 is not any more flown by current. This causes contact [1-2] to turn to a closed status and contact [1a-2a] to turn to an open status.

Therefore, in complementary circuit 22 a current flows that operates alarm 29, and in complementary circuit 21 no current flows, then contacts [3-4] and [5-6] turn to an open status.

It should be noted that residual current circuit breaker 200 should be calibrated taking into account both of an unavoidable loss by the circuit towards ground, and of the current that flows and maintains a bridge comprising resistance R closed, for activating the apparatus according to the invention.

b) Irregular Operation with Failure Owing to Broken Induced Circuit.

If contacts [7-8] and [9-10] are closed, and induced circuit 15 breaks, in branch circuit 30 no current flows and contacts [1-2] turn to a closed status; complementary circuit 22 is then supplied and operates the warning device. Contacts [1a-2a], instead, turn to an open status, and then in complementary circuit 21 no current flows, and contacts [3-4] and [5-6], normally open, turn to an open status.

c) Irregular Operation with Failure Owing to a Gripped Mechanism of Relay 11 and Current Flow in the Induced Circuit Higher than Allowable Limits.

If contacts [7-8] and [9-10] are closed, and a leakage occurs towards ground higher than an allowable limit, for example 15 milliampère, then the RRC inductor intervenes that opens branch circuit 30; since no current flows in branch circuit 30, contacts [1-2] turn to a closed status, so that in complementary circuit 22 a current flows and warning device 29 is operated; contacts [1a-2a] instead turn to an open status, and interrupt current flow in complementary circuit 21, then contacts [3-4] and [5-6], normally open, turn to an open status.

d) First Installation of the Circuit Breaker.

The installation of residual current circuit breaker 200, equipped with the apparatus according to the above described invention, is carried out according to the following steps:

sectioning members Z1 and Z2 are turned to an open status;

contacts [7-8] and [9-10] are turned to a closed status: contacts [3-4] and [5-6] are open, then in induced circuit 15 and in branch circuit 30 there is no current;

sectioning members Z1 and Z2 are turned to a closed status; the circuit is supplied by contacts [24-25] and [26-27], normally closed, of relay 23; therefore, in induced circuit 15 a current flows that, through branch circuit 30, opens contact [1-2] and closes contact [1a-2a]. This way, complementary circuit 21, through relay 20, closes contacts [3-4] and [5-6] and normally closed contacts [24-25] and [26-27] of relay 23 are turned to an open status.

### e) Interruption of the Supply for External Causes, and its Following Restoration.

The circuit is not supplied any more from the outside, so contacts [3-4] and [5-6] are turned to an open status because in complementary circuit 21 no current flows any more, and also because in branch circuit 30 no current flows any more, and then contact [1-2] turns to a closed status whereas contact [1a-2a] turns to an open status.

Therefore, at the restoration of the supply, contacts [3-4] and [5-6] are open, whereas contacts [7-8] and [9-10] are closed. Contacts [24-25] and [26-27] of relay 23, turn to an open status, but with a small delay, such that relay 20 has time for stopping contacts [3-4] and [5-6], after having given a voltage pulse to phase conductor F and neutral conductor N of the circuit, thus allowing the restoration of the status of operation of the apparatus.

f) Total Failure of the Apparatus According to the Invention Associated to the Residual Current Circuit Breaker.

In this case, contacts [3-4] and [5-6] are normally open; therefore, the apparatus carries out in any case its function, since it provides no supply to residual current circuit breaker 200.

The key T and test circuit 18, similarly to the corresponding devices present in the residual current circuit breakers of the prior art (FIG. 3A), can be used for testing the correct operation of residual current circuit breaker 200, immediately after the installation. The resistance 19 is chosen in a way such that, pushing test button T, test circuit 18 is flown by a current of intensity suitable to induce in the induced circuit a current of enough intensity to cause relay 11 to intervene, but also to activate warning device 29 and contactor 20, turning contacts [3-4] and [5-6] to an open status.

Instead, by pushing test button T₁, after having interrupted the supply to the load downstream, the current in induced circuit 15 does not flow any more, testing the validity of the apparatus according to the invention.

RRC contact, normally closed, has a probability of failure much less than mechanism 11a of residual current circuit breaker 200, according to the international tables of the mean times between failures (MTBF). This depends on that in RRC contact there are no springs, moving shafts or other, and all the movements are due only to the magnetic field. If, instead of RRC inductor, a fuse is mounted, the risk of failure would be substantially zero, however in case of operation of the apparatus, the restoration thereof to start again the supply to the protected circuit, would be more complicated, for change of the fuse.

With reference to FIG. 2, relative to a second exemplary general embodiment, the single-phase residual current circuit breaker 300 comprises:

a contactor 40, having normally closed contacts [3-4] and [5-6] respectively on phase conductor F and on neutral conductor N, arranged upstream from contacts [7-8] and [9-10] of the residual current circuit breaker;

a warning device 29,

two complementary circuits 41 and 42, supplied directly by the mains, which work respectively for operation of contactor 40 and of warning device 29. In series to such uses, in circuits 41 and 42 there are contacts [1-2] of a relay 51.

a branch circuit 30 for operating the relay 51, on which the contacts are arranged in series of two “dry reed relays” RRA, normally open, and RRC, normally closed; branch circuit 30 is supplied by the mains by a transformer TR;

The two windings 34 and 36 of the relay RRA and RRC, located in series on induced circuit 15 of residual current circuit breaker 300.

a capacity C arranged on a conductor 33 in series with the contact of a test button T1, between phase conductor F and neutral conductor N, of value adapted to allow a current of a few milliampère to flow in induced circuit 15;

Upstream from contactor 40, for protection against short circuits, a switch is then arranged with fuses Z1 and Z2.

Like for the case of circuit breaker 200, alternatively, instead of RRC inductor a fuse can be used; instead of transformer TR another system can be used, for example an electronic feeder.

In branch circuit 30 a current flows if induced circuit 15 is undamaged, since RRA inductor closes its contacts (normally open) even for minimum current values (predetermined) and then intervenes in case of failure, breaking induced circuit 15; RRC inductor, instead, opens its contacts (normally closed) only for current values higher than a predetermined threshold and then intervenes in case of failure, which is caused to a gripped mechanism of relay 11.

Then, in case of break of induced circuit 15, in branch circuit 30 there is no current, therefore contacts [1-2] turn to a closed status; in complementary circuits 42 and 41 a current flows, therefore device 29 emits a warning signal, and contacts [3-4] and [5-6], of normally closed type, turn to an open status.

In the event that induced circuit 15 is undamaged, but a current flows higher than that necessary to operate relay 11, and that however contacts [7-8] and [9-10] do not open because the releasing device is blocked, then RRC inductor intervenes, suitably calibrated, which opens branch circuit 30. Even in this case in branch circuit 30 there is no current, therefore contacts [1-2], normally closed, let the current flow, supplied by the mains supply, in complementary circuits 42 and 41, operating alarm 29 and opening normally closed contacts [3-4] and [5-6] of contactor 20.

Alternatively, instead of capacity C, for causing a small current to flow in induced circuit 15 a resistance can be used, as in case of circuit breaker 200.

Hereinafter the operation is described of the single-phase residual current circuit breaker 300, equipped with the apparatus according to the above described invention, in the following possible situations:

a) regular operation without failure,
b) irregular operation with failure owing to broken induced circuit,
c) irregular operation with failure owing to a gripped mechanisms and current flow in the induced circuit higher than allowable limits,
d) first installation of the circuit breaker,
e) interruption of the supply for external causes and its restoration,
f) total failure of the apparatus according to the invention associated to the residual current circuit breaker.

a) Regular Operation without Failure

Contacts [7-8] and [9-10] are closed, then in induced circuit 15 and in branch circuit 30 current flows that, by the relay 51, keeps open [1-2] contacts and then in complementary circuits 42 and 41 there is no current; this way device 29 does not emit a warning signal, and, by relay 40, contacts [3-4] and [5-6] are not turned to an open status.

In case of regular operation of residual current circuit breaker 300, without failure, contacts [7-8] and [9-10] turn to an open status, because in induced circuit a current flows adapted to trigger relay 11. The current circulating in induced circuit 15 causes the contacts of RRC inductor to turn to an open status, so that in branch circuit 30 no current flows any more. This causes contact [1-2] to turn to a closed status. Therefore, contact [1-2] is closed and in complementary circuits 42 and 41a current flows; this way warning device 29 is operated, and normally closed contacts [3-4] and [5-6], are turn to an open status.

b) Irregular Operation with Failure Owing to Broken Induced Circuit.

If contacts [7-8] and [9-10] are closed, and induced circuit 15 breaks, in branch circuit 30 no current flows and contacts [1-2] turn to a closed status; in complementary circuits 42 and 41 a current flows and operates respectively warning device 29, and relay 40, which opens normally closed contacts [3-4] and [5-6].

c) Irregular Operation with Failure Owing to a Gripped Mechanism of Relay 11 and Current Flow in the Induced Circuit Higher than Allowable Limits.

If contacts [7-8] and [9-10] are closed, and a leakage occurs towards ground higher than an allowable limit, for example of 15 milliampère, if the residual current circuit breaker has a value of IΔn equal to 30 milliampère, and then the RRC inductor intervenes that opens branch circuit 30; since no current flows in circuit 30, contacts [1-2] turn to a closed status, so that in complementary circuits 42 and 41 a current flows, operating respectively warning device 29 and relay 2, which opens normally closed contacts [3-4] and [5-6].

### d) First Installation of the Circuit Breaker

The installation of residual current circuit breaker 300, having an apparatus according to the above described invention, is carried out according to the following steps:

sectioning members Z1 and Z2 are turned to an open status;

contacts [7-8] and [9-10] are turned to a closed status: since contacts [3-4] and [5-6] are closed, in induced circuit 15 and in branch circuit 30 there is no current, contacts [1-2] are closed and in complementary circuits 42 and 41 there is no current, then contacts [3-4] and [5-6] remain closed;

sectioning members or contacts Z1 and Z2 are turned to a closed status, then in induced circuit 15 and in branch circuit 30 a current flows, contact [1-2] turns to an open status and in complementary circuits 42 and 41 there is no current, then contacts [3-4] and [5-6] remain closed.

### e) Interruption of the Supply for External Causes, and its Following Restoration.

Since the supply from the outside of the circuit is interrupted, contacts [3-4] and [5-6] remain closed because in complementary circuit 42 no current flows any more, and also because in branch circuit 30 no current flows any more, and then contact [1-2] turns to an open status. Therefore, at restoration of the supply contacts [3-4] and [5-6] are turned to a closed status, as well as contacts [7-8] and [9-10], thus allowing the restoration of the status of operation of the apparatus.

### f) Total Failure of the Apparatus According to the Invention Associated to the Residual Current Circuit Breaker.

In this case, contacts [3-4] and [5-6] are normally closed and therefore the apparatus accepts its validity to obtain the results.

Also for switch 300 similar considerations to the above concerning the operation of circuit breaker 200 are valid, relatively to the function of the test buttons T and T1; the same occurs for the probability of failure and the operations of restoration of RRC contact or of a possible fuse that the replaces it with a same function.

In FIGS. 1A and 2A residual current circuit breakers 400 and 700 are diagrammatically shown according to other exemplary embodiments of the invention, which are derived, respectively, from the embodiments previously described and shown in FIGS. 1 and 2. For breaking the supply, in case of failure of the residual current circuit breaker, the device 400 provides a contactor 20 with normally open contacts, whereas device 700 has a contactor 40 with normally closed contacts. Complementary circuits 21, 22, 41, 42 for operating contactors 20 and 40, as well as warning device 29, are for this reason similar to those shown in FIGS. 1 and 2. In switches 400 and 700 a branch circuit is present that carries out the same function of circuit 30 of FIGS. 1 and 2, and is split into two parts, i.e.:

a first part 50a that has a winding 53 linked to a second ring 56 on which induced circuit 15 is wound and, in series to winding 52, it has the windings of inductors RRA and RRC,

a second part 50b similar to circuit 30 of FIGS. 1 and 2, supplied by transformer TR; on this part the contacts are arranged of the RRA and RRC inductors and relay 31 of FIG. 4 or relay 51 of FIG. 7.

The operation of the residual current circuit breakers 400 and 700 is completely analogue, respectively, to that of devices 200 and 300. Even in this case the description on devices 200 and 300 are valid, relatively to the possibility of:

using a fuse instead of RRC inductor;

to replace transformer TR with another system, for example an electronic feeder;

using a capacity C instead of a resistance R, arranged between phase conductor F and neutral conductor N, for causing a small current to flow in the induced circuit;

carry out the test using the test buttons T and T1.

In FIGS. 1B and 2B two other residual current circuit breakers 500 and 800 are diagrammatically shown according to exemplary embodiments of the invention, also derived, respectively, from the embodiments previously described and shown in FIGS. 1B and 2B. They comprise, respectively, a contactor 20 with normally open contacts and a contactor 40 with normally closed contacts for breaking the supply in case of failure of the residual current circuit breaker. Differently from the devices 200 and 300, each circuit breaker has, in addition to a first induced circuit 15, a second induced circuit 62, which has also a winding 63, linked to ring 16. Instead of branch circuit 30, there is a circuit 66 that has the contacts of further inductors RRA1 and RRC1 arranged in series with respect to the contacts of the inductors RRA and RRC. The windings of the inductors RRA1 and RRC1 is located on the induced circuit 62, in series to winding 63.

Also in this case what described about switches 200 and 300 is valid, relatively to the possibility of:

use of the fuse instead of inductors RRC and RRC1;

to replace transformer TR with another system, for example an electronic feeder;

using a capacity C instead of resistance R, arranged between phase conductor F and neutral conductor N, for causing a small current to flow in the induced circuit;

carry out of the test using test buttons T and T1.

In FIGS. 1C and 2C two further residual current circuit breakers 600 and 900 are diagrammatically shown, as further exemplary embodiments of the invention. Such switches are similar respectively to devices 500 and 800, however, instead of induced circuit 62, having a winding linked to ring 16, there is an induced circuit 82, similar to circuit 62 but with a winding linked to a ring 76 different from ring 16, and crossed also by phase conductor F and neutral conductor N.

Switches 600 and 900 with respect to the switches 500 and 800, have the different feature of having two induced circuits each with its own ring and operate in a way completely similar to switches 500 and 800.

Also in this case what described about the devices previous is valid, relatively to the possibility of:

using the fuse instead of RRC and RRC1 inductors;

replacing transformer TR with another system, for example an electronic feeder;

using a capacity C instead of resistance R, arranged between phase conductor F and neutral conductor N, for causing a small current to flow in the induced circuit;

effecting the test using test buttons T and T1.

In the cases where the need of the supply is of primary importance and cannot be interrupted, two or more residual current circuit breakers can be installed upstream having the above described system, and arranged so that as a residual current circuit breaker does not operate, automatically, the successive residual current circuit breaker is activated.

The circuits of the apparatus above described can be transformed and printed as electronic circuit boards.

Analogous examples can be made of three-phase circuit breakers, with or without neutral conductor, having a safety apparatus for according to the invention, similar to devices 200-900 above described, with modifications obvious to a skilled reader.

The foregoing description of a specific embodiment will so fully reveal the invention according to the conceptual point of view, so that others, by applying current knowledge, will be able to modify and/or adapt for various applications such an embodiment without further research and without parting from the invention, and it is therefore to be understood that such adaptations and modifications will have to be considered as equivalent to the specific embodiment. The means and the materials to realise the different functions described herein could have a different nature without, for this reason, departing from the field of the invention. It is to be understood that the phraseology or terminology employed herein is for the purpose of description and not of limitation.

1. Residual current circuit breaker or switch (200, 300, 400, 500, 600, 700, 800, 900) for an electric line comprising at least a first and a second conductors (F,N), said conductors (F,N) being flown in use by an entering current or by an exiting current, said switch comprising:
a first mobile contact, arranged between a first couple of points (9-10) of at least one conductor of said line, such that moving said contact to an open position or to a closed position, a current flow between the points (9-10) of said couple is respectively prevented or allowed;
an induced current circuit (15), called also induced circuit, linked to said line downstream of said first couple of points (9-10), said induced circuit (15) being flown by a current having an intensity increasing as the difference between said entering and exiting currents grows, and of null intensity in case said currents are alike, said difference being called hereinafter differential current,
a first electromechanical means (11) for moving said first contact from said closed position to said open position, said first means (11) being operated by said induced circuit (15),
said induced circuit (15) and said first electromechanical means (11) being adapted to open said first contact when said differential current exceeds a maximum predetermined value,
said switch being wherein it comprises an apparatus for detecting conditions of failure and ensuring its operation, said apparatus comprising:
an emergency device (20, 40, 29);
a detecting means for measuring a condition of failure of said switch, said condition of failure being selected from the group comprised of:
an impediment to the current flow in said induced circuit (15), in particular a break of the induced circuit (15),
a mechanical block of said first electromechanical means (11), in particular a gripped electromechanical releasing device of the residual current circuit breaker,
a combination of said impediment and of said block,
an electric means for operating said emergency device (20, 40, 29),
such that said emergency device is activated when said detecting means detects said condition of failure,
characterised in that said detecting means for measuring a condition of failure comprises a means for causing a test current to flow in a permanent way in said induced circuit (15), said test current being less than a current necessary to operate said first electromechanical means (11), said test current being higher than a minimum detectable current, and in that said means for causing said test current to flow in a permanent way in said induced circuit (15) comprises a branch conductor (33) arranged between two conductors (F,N) of said line, said branch conductor (33) comprising an impedance (R,C) such that said branch conductor (33) in use is flown by an assigned current, to create a differential current between said two conductors (F,N) of said line in the portion linked to said induced circuit (15) and to create in said induced circuit (15) a current not less than said minimum detectable current.

2. Residual current circuit breaker according to claim 1, wherein said emergency device comprises:
a second mobile contact (5-6) arranged between a second couple of points of a conductor of said line,
a second electromechanical means for moving said second contact (5-6) from a closed position to an open position and vice-versa,
and said second electromechanical means moves said second contact (5-6) from said closed position to said open position when said detecting means detects said condition of failure.

3. Residual current circuit breaker according to claim 1, wherein said emergency device comprises:
a warning device (29), optical and/or acoustic or of other kind, of at least said condition of failure,
an electric means for operating said warning device, such that said electric means for operating said warning device generates a warning signal when said detecting means detects said condition of failure.

4. Residual current circuit breaker according to claim 3, wherein said warning device (29) is adapted to transmit said signalling to a remote location.

5. Residual current circuit breaker according to claim 1, wherein said line is selected from the group comprised of:
a single-phase line having a phase conductor and a neutral conductor;
a three-phase line having three phase conductors;
a three-phase line having three phase conductors and a neutral conductor.

6. Residual current circuit breaker according to claim 1, wherein said means for measuring a condition of failure comprises a means to provide an activation current to said electric means for operating said emergency device (20, 40, 29) when said current circulating in said induced circuit (15) is less than said minimum detectable current.

7. Residual current circuit breaker according to claim 1, wherein said means for measuring a condition of failure comprises a means to provide an activation current to said electric means for operating said emergency device (20, 40, 29) when said current circulating in said induced circuit (15) is higher than said current necessary to operate said first electromechanical means (11).

8. Residual current circuit breaker according to claim 1, wherein said impedance is selected from the group comprised of:
a mainly resistive element (R),
a mainly capacitive element (C).

9. Residual current circuit breaker according to claim 1, wherein a normally closed contact is arranged in series to said impedance (R,C), said contact having a command (T1) accessible to an user, so that said user, through said command (T1), can test the operation of the electric means for operating said emergency device (20, 40, 29), such that the validity of the apparatus according to the invention is tested.

10. Residual current circuit breaker according to claim 6, wherein said means to provide an activation current to said electric means for operating said emergency device (20, 40, 29) comprises:
a complementary circuit (21, 22, 41, 42) adapted to connect/disconnect said electric means with a power supply independent from said line, between two points of said complementary circuit (21, 22, 41, 42) a third mobile contact (1-2, 1a-2a) being arranged such that said third contact (1-2, 1a-2a) moves from a closed position to an open position, respectively allowing and avoiding a current to flow in said complementary circuit (21, 22, 41, 42), in order to supply or not to supply current to said electric means for operating said emergency device (20, 40, 29),
an electric means (31, 51) for moving said third contact (1-2, 1a-2a) from said closed position to said open position and vice-versa.

11. Residual current circuit breaker according to claim 10, wherein a branch circuit (30, 50b, 66) is provided adapted to connect said electric means (31, 51) for moving said third contact (1-2, 1a-2a) with a power supply (TR) independent from said line, between two points of said branch circuit a fourth mobile contact (35) being provided arranged such that moving said fourth contact (35) from a closed position to an open position, respectively a current flow in said branch circuit (30, 50b, 66) is allowed or interrupted, in order to supply or not supply a current to said electric means (31, 51) for moving said third contact (1-2, 1a-2a), said fourth mobile contact (35) being open when said induced circuit (15) is flown by a current less than said minimum detectable current.

12. Residual current circuit breaker according to claim 10, wherein a branch circuit (30, 50b, 66) is provided adapted to connect said electric means (31, 51) for moving said third contact (1-2, 1a-2a) with a power supply (TR) independent from said line, between two points of said branch circuit (30, 50b, 66) a device being arranged selected from the group comprised of:
a fifth mobile contact (37) arranged between two points of said branch circuit (30, 50b, 66), such that moving said fifth contact from a closed position to an open position, respectively a current flow in said branch circuit (30, 50b, 66) is allowed or interrupted, in order to supply or not to supply a current to said electric means (31, 51) for moving said third contact (1-2, 1a-2a), said fifth mobile contact (37) being open when said induced circuit (15) is flown by a current higher than said current necessary to operate said first electromechanical means (11),
a means for interrupting a current flow in said induced circuit (15) or in an auxiliary induced circuit (50a, 62) linked to said induced circuit (15), when said induced circuit (15) and/or said auxiliary induced circuit are flown by a current higher than said current necessary to operate said first electromechanical means (11), wherein, in particular, said means for interrupting a current flow comprises one or more fuses.

13. Residual current circuit breaker according to claim 11, wherein said fourth contact (35) or said fifth contact (37) is a relay having an inductor winding (34, 36), supplied by said induced circuit (15) or by an auxiliary induced circuit (50a, 62) linked to said induced circuit (15), flown by an increasing/decreasing current when said induced circuit (15) or said auxiliary induced circuit (50a, 62) is flown by an increasing/decreasing current, said fourth contact (35) being normally open, said fifth contact (37) being normally closed, wherein said relay is, in particular, a “dry reed relay”.

14. Residual current circuit breaker (400, 500, 700, 800) according to claim 13, wherein said auxiliary induced circuit (50a, 62) is flown by a secondary current induced by a primary current in a device of electromagnetic induction (56-52, 16-63), said primary current being selected from the group comprised of:
said differential current,
a current circulating in said induced circuit (15).

15. Residual current circuit breaker (400, 700) according to claim 14, wherein said primary current flows in said induced circuit (15), and wherein said device of induction (56-52) comprises a conductor linked in use with said induced circuit (15).

16. Residual current circuit breaker according to claim 2, wherein said second mobile contact (5-6) is selected from the group comprised of:
a normally open contact, such that in the situation of total failure of said apparatus, said apparatus provides no supply to residual current circuit breaker and carries out in any case its function, and said third contact is normally open,
a normally closed contact, and said third contact is normally closed.

17. Residual current circuit breaker (200, 400, 500, 600) according to claim 2, wherein said second contact (5-6) is normally open, and a sixth mobile normally closed contact (26-27) is arranged between a third couple of points respectively upstream and downstream of said second contact (5-6), said sixth contact (26-27) having a breaker means (23) that can be supplied with said residual current circuit breaker, said breaker means (23) opening said contact with a delay such that, when supplying said residual current circuit breaker, said second electromechanical means close said second contact (5-6) before that said sixth contact (26-27) is open, in order to restore automatically the supply to said line and the operation of said residual current circuit breaker in case of lack of voltage from a mains supply.

18. Residual current circuit breaker (300) according to claim 1, comprising a test means (18) having a conductor arranged between two conductors (F,N) of said line, said conductors comprising:
a normally open contact having a closing command (T) accessible to a user,
an mainly resistive element (19), such that said conductor is flown by a current only when said contact is closed, said current being higher than said maximum predetermined value of differential current, such that said user, operating said command (T), tests the operation of said first electromechanical means (11) for moving said first contact.

19. Residual current circuit breaker according to claim 1, wherein said means for measuring a condition of failure and said electric means for operating said emergency device (20, 40, 29) comprise a circuit selected from the group comprised of:
circuits comprising an electromechanical relay,
electronic integrated circuits,
a combination of said circuits.

20. A safety apparatus for detecting conditions of failure and ensuring the operation of a residual current circuit breaker or switch (100),
wherein said residual current circuit breaker comprises at least a first and a second conductors (F,N), said conductors (F,N) being flown in use by an entering current or by an exiting current, said switch comprising:
a mobile contact, arranged between a first couple of points (9, 10) of at least one conductor of said line, such that moving said contact to an open position or to a closed position, a current flow is respectively prevented or allowed between the points (9, 10) of said couple;
an induced current circuit (15), called also induced circuit, linked to said line downstream of said first couple of points (9, 10), said induced circuit (15) being flown by a current of intensity increasing as the difference grows between said entering and exiting currents, and of null intensity in case said currents are alike, said difference being called hereinafter differential current,
an electromechanical means (11) for moving said contact from said closed position to said open position, said electromechanical means (11) being operated by said induced circuit (15),
said induced circuit (15) and said first electromechanical means (11) being adapted to open said contact when said differential current exceeds a maximum predetermined value,
wherein apparatus comprises
an emergency device (20, 40, 29);
a detecting means for measuring a condition of failure of said switch, said condition of failure being selected from the group comprised of:
an impediment to the current flow in said induced circuit, (15), in particular a break of the induced circuit (15),
a mechanical block of said first electromechanical means (11), in particular a gripped electromechanical releasing device of the residual current circuit breaker,
a combination of said impediment and of said block,
an electric means for operating said emergency device (20, 40, 29);
such that said emergency device is activated when said detecting means detects said condition of failure,
characterised in that said detecting means for measuring a condition of failure comprises a means for causing a test current to flow in a permanent way in said induced circuit (15), said test current being less than a current necessary to operate said first electromechanical means (11), said test current being higher than a minimum detectable current, and in that said means for causing said test current to flow in a permanent way in said induced circuit (15) comprises a branch conductor (33) arranged between two conductors (F,N) of said line, said branch conductor (33) comprising an impedance (R,C) such that said branch conductor (33) in use is flown by an assigned current, to create a differential current between said two conductors (F,N) of said line in the portion linked to said induced circuit (15) and to create in said induced circuit (15) a current not less than said minimum detectable current.

21. (canceled)
